(19) United States
(12) Patent Application Publication
(10) Pub. No.: US 2006/0086449 A1
(43) Pub. Date: Apr. 27, 2006

(54) Semiconductor device having element portion and control circuit portion

(75) Inventor: Yoshiaki Nakayama, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/251,776

(22) Filed: Oct. 18, 2005

(30) Foreign Application Priority Data
Oct. 25, 2004 (JP) 2004-309940

(51) Int. Cl. B32B 37/00

(52) U.S. Cl. 156/86

(57) ABSTRACT

A semiconductor device comprising: an element portion having a heat generation portion; a control circuit portion having a control circuit for controlling the element portion; and a metal member. The element portion and the control circuit portion are adjacently disposed oh a surface portion of a semiconductor substrate. The metal member as an external electrode for the element portion is disposed directly on the element portion through an interlayer insulation film. The metal member is also disposed directly on the control circuit portion through the interlayer insulation film.

### CROSS REFERENCE TO RELATED APPLICATION

This application is based on Japanese Patent Application No. 2004-309940 filed on Oct. 25, 2004, the disclosure of which is incorporated herein by reference.

### FIELD OF THE INVENTION

The present invention relates to a semiconductor device having a power portion and a control circuit portion.

### BACKGROUND OF THE INVENTION

Multiple power elements are formed on a surface portion of a semiconductor substrate. These elements are connected in parallel by two aluminum wiring layers. This type of a semiconductor device is disclosed in, for example, Japanese Laid-Open patent Publication No. H8-125176, which corresponds to U.S. Pat. No. 5,672,894.

In general, a semiconductor device for a power element includes a power portion and a control circuit portion, which are adjacently disposed on a surface portion of a semiconductor substrate. The power portion includes multiple power elements, which are connected in parallel each other. The control circuit portion includes a control circuit for controlling the power element. This device is named as a power IC. A power metal member as an external electrode of the power element is formed on the power portion through an interlayer insulation film so that an on-state resistance of the power portion is reduced.

In general, it is required for the power IC having the power element and the control circuit integrated in one chip to reduce a temperature increase of a chip temperature caused by heat generated in the power element. The power element is formed on a principal surface of the semiconductor substrate. When the power IC is molded with a mold package, heat radiation from the principal surface side of the substrate is only performed through a wire bonded to the power metal member. Accordingly, the power IC includes the heat sink for radiating heat. The heat sink is disposed on the backside of the chip 1. The chip is made of silicon so that heat resistance of the chip becomes high. Therefore, it is required to radiate heat effectively from the principal surface side of the chip so that heat radiation is increased.

### SUMMARY OF THE INVENTION

In view of the above-described problem, it is an object of the present invention to provide a semiconductor device having an element portion and a control circuit portion.

A semiconductor device includes: an element portion having a heat generation portion; a control circuit portion having a control circuit for controlling the element portion; and a metal member. The element portion and the control circuit portion are adjacently disposed on a surface portion of a semiconductor substrate. The metal member as an external electrode for the power element is disposed directly on the element portion through an interlayer insulation film. The metal member is also disposed directly on the control circuit portion through the interlayer insulation film.

In this case, since the metal member as the external electrode of the power portion is formed directly on the power portion, the on-state resistance of the device becomes smaller. Further, since the metal member is disposed not only on the power portion but also on the control circuit portion, the area and the volume of the metal member are increased. Thus, the heat radiation through the metal member becomes larger. Further, the number of the bonding wires can be increased; and therefore, the heat radiation through the bonding wires becomes larger. Further, the heat capacity of the metal member is increased so that the temperature increase caused by instantaneous heat generation of the power portion is effectively reduced.

Alternatively, the metal member may cover almost all the element portion. The metal member may cover almost all the control circuit portion.

Alternatively, the semiconductor device further includes a heat sink. The element portion and the control circuit portion are disposed on a foreside of the substrate. The heat sink is disposed on a backside of the substrate. The heat sink and the metal member are capable of transmitting heat generated in the heat generation portion so that the heat is discharged. The heat sink may cover almost all the backside of the substrate, and the metal member may cover almost all the foreside of the substrate.

### BRIEF DESCRIPTION OF THE DRAWINGS

The above and other objects, features and advantages of the present invention will become more apparent from the following detailed description made with reference to the accompanying drawings. In the drawings:

FIG. 1 is a cross sectional view showing a power IC according to a preferred embodiment of the present invention;

FIG. 2 is a plan view showing a layout of main parts in the power IC shown in FIG. 1;

FIGS. 3A and 3B are plan views showing power ICs having different power portions and control circuit portions, respectively, according to first and second modifications of the preferred embodiment;

FIG. 4 is a cross sectional view showing a power IC having multiple wires according to a third modification of the preferred embodiment;

FIG. 5 is a cross sectional view showing a power IC mounted on a printed circuit board through a solder ball, according to a fourth modification of the preferred embodiment;

FIG. 6 is a plan view showing a layout of main parts in a power IC according to a fifth modification of the preferred embodiment;

FIG. 7 is a cross sectional view showing a power IC according to a sixth modification of the preferred embodiment;

FIG. 8 is a cross sectional view showing a power IC as a comparison of the preferred embodiment;

FIG. 9 is a plan view showing a layout of main parts in the power IC shown in FIG. 8;

FIG. 10 is a cross sectional view showing a simulation model of a power IC according to the preferred embodiment;

FIG. 11 is a circuit diagram showing an equivalent thermal circuit of the power IC according to the preferred embodiment;

FIG. 12 is a table showing material, heat resistance, heat capacity and dimensions of each part of the power IC according to the preferred embodiment; and

FIG. 13 is a graph showing a relationship between a time and a temperature of a heat generation portion in the power IC according to the preferred embodiment.

### DETAILED DESCRIPTION OF THE PREFERRED EMBODIMENT

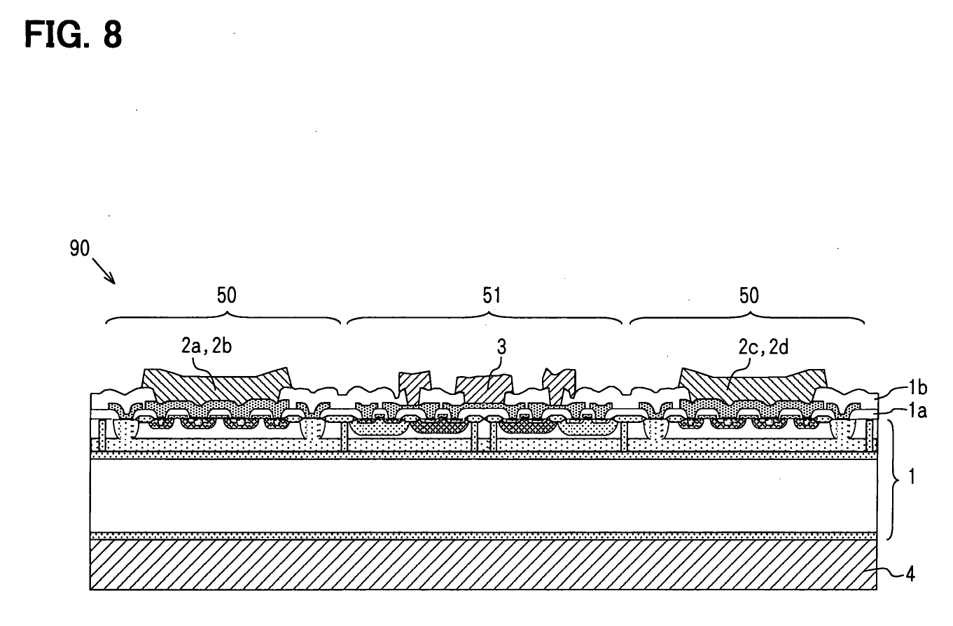

FIG. 8 is a power IC 90 as a comparison of a first embodiment. FIG. 9 shows a layout of main parts of the power IC 90. The power IC 90 as a semiconductor device includes a power portion 50 and a control circuit portion 51. The power portion 50 as an electric element portion includes multiple power elements, which are connected in parallel each other. In FIG. 9, the power portion 50 is composed of two systems. The control circuit portion 51 includes a control circuit for controlling the power elements. The power portion 50 and the control circuit portion 51 are adjacently formed on a surface portion of a semiconductor substrate as a semiconductor chip 1. The chip 1 has a SOI construction. The IC 90 has a heat sink 4 for radiating heat, and disposed on a backside of the chip 1. In FIG. 9, the power portion 50 is shown as an area surrounded with a broken line, and the control circuit portion 51 is shown as an area surrounded with a dotted line.

In the power IC 90, power metal members 2a-2d as an external electrode of the power element are formed on the power portion 50 through interlayer insulation films 1a, 1b. The power element as a power electric device formed in the power IC 90 is a MOS type transistor. Thus, the power element works as a heat generation portion. Each power metal member 2a-2d connects between sources or drains of the MOS type transistors formed in two systems of the power portion 50.

A pad 3 as an external electrode of the control circuit portion 51 is disposed on a periphery portion of the control circuit portion 51. Therefore, the pad 3 is not disposed directly on the circuit portion 51 in order to avoid a bonding failure.

In this case, the power element is formed on a principal surface of the semiconductor substrate 1. When the power IC 90 is molded with a mold package, heat radiation from the principal surface side of the substrate 1 is only performed through a wire bonded to the power metal members 2a-2d. Accordingly, the power IC 90 includes the heat sink 4 for radiating heat. The heat sink 4 is disposed on the backside of the chip 1. The chip 1 is made of silicon so that heat resistance of the chip 1 becomes high. Therefore, it is required to radiate heat effectively from the principal surface side of the chip 1 so that heat radiation is increased.

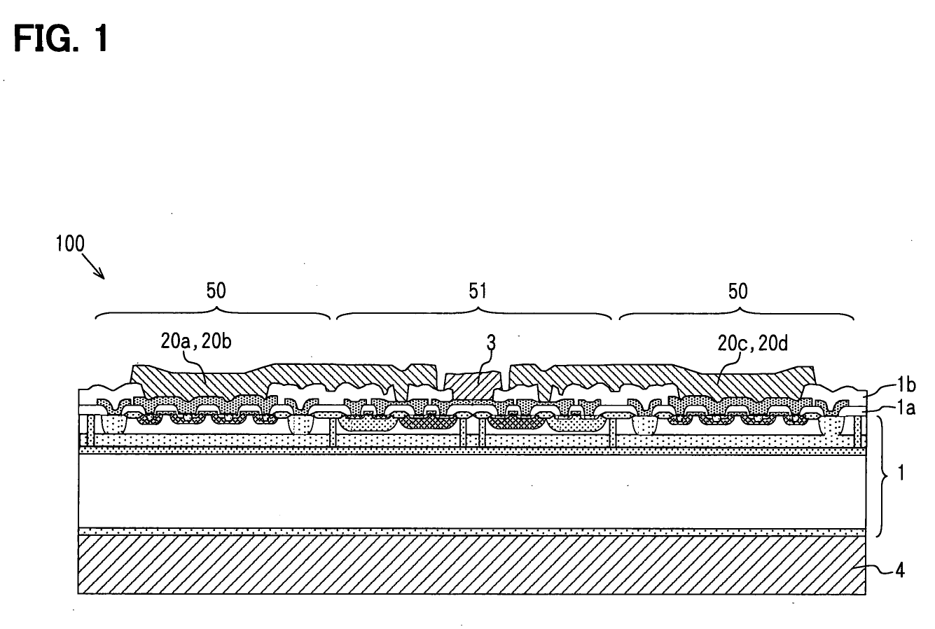

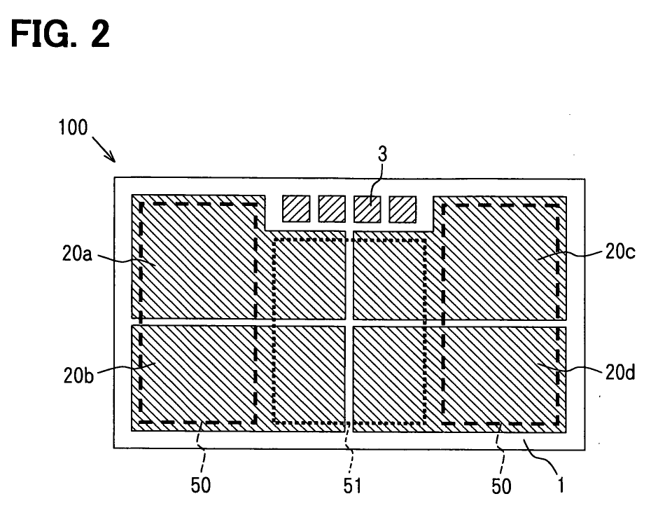

In view of the above problem, a power IC 100 according to a preferred embodiment of the present invention shown in FIG. 1 is manufactured. The power IC 100 includes a power portion 50 and a control circuit portion 51. The power portion 50 includes multiple power elements, which are connected in parallel each other, and a control circuit portion 51, which includes a control circuit for controlling the power elements. The power portion 50 has two systems. The power portion 50 and the control circuit portion 51 are adjacently formed on a surface portion of a semiconductor substrate 1.

Power metal members 20a-20d as an external electrode of the power elements are formed directly on the power portion 50 through interlayer insulation films 1a, 1b. The power metal member 20a-20d is made of metal such as aluminum and copper, which has excellent electric conductivity and thermal conductivity. The power element is a MOS transistor. Each power metal member 20a-20d connects in parallel between sources or drains of MOS transistors in two systems of the power portion 50. Here, the heat sink 4 is also made of a material having excellent electric conductivity and thermal conductivity.

The power metal member 20a-20d is formed not only directly on the power portion 50 but also directly on the control circuit portion 51. In the power IC 100, since the power metal member 20a-20d is formed directly on the power portion 50, the on-state resistance of the power IC 100 becomes lower. Further, the power metal member 20a-20d is also disposed directly on the control circuit portion 51. Therefore, an area and a volume of the power metal member 20a-20d in FIG. 1 becomes larger than the power metal member 2a-2d of the power IC 90 shown in FIG. 8. Thus, as the area of the power metal member 20a-20d becomes larger, heat radiation efficiency of the power metal member 20a-20d becomes larger. Further, the number of wires for bonding to the power metal member 20a-20d also becomes larger. Thus, heat radiation amount by heat conduction through the wires is increased. Furthermore, as the volume of the power metal member 20a-20d becomes larger, heat capacity of the power metal member 20a-20d becomes larger. Thus, temperature increase caused by instantaneous heat generation of the power element is also limited.

Preferably, the area and the volume of the power metal member 20a-20d are large in order to increase heat radiation efficiency of the power IC 100. Accordingly, as shown in FIG. 1, the power metal member 20a-20d covers almost all the power portion 50. Further, the power metal member 20a-20d disposed on the control circuit portion 51 covers almost all the control circuit portion 51.

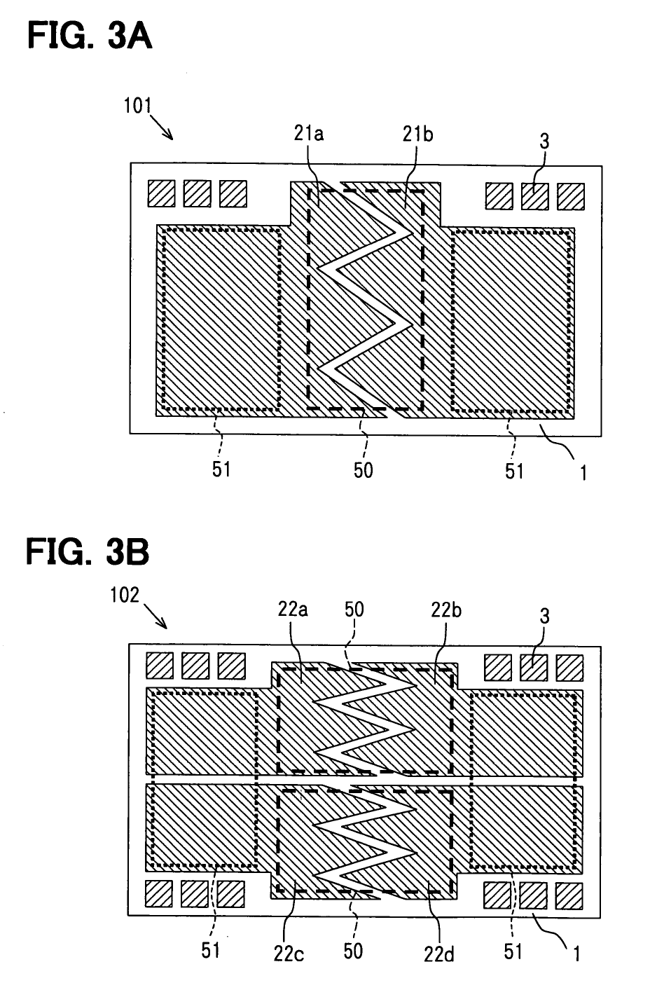

Here, the power portion 50 and the control circuit portion 51 may have other constructions. FIGS. 3A and 3B shows power ICs 101, 102 having different power portion 50 and control circuit portion 51, which are different from those shown in FIG. 1.

In the power IC 101, one system of the power portion 50 is disposed on the center of the IC 101. Further, the control circuit portion 51 is divided into two parts, which are disposed on both sides of the power portion 50. In the power IC 102, the power portion is divided into two systems, which are disposed on the center of the IC 102. Further, the control circuit portion 51 is also divided into two parts, which are disposed on both sides of the power portion 50.

The power metal members 21a, 21b, 22a-22d as an external electrode corresponding to a source and a drain are also disposed not only on the power portion 50 but also on the control circuit portion 51. A plane shape of each power metal member 21a, 21b, 22a-22d may be different from the shape shown in FIGS. 3A and 3B.

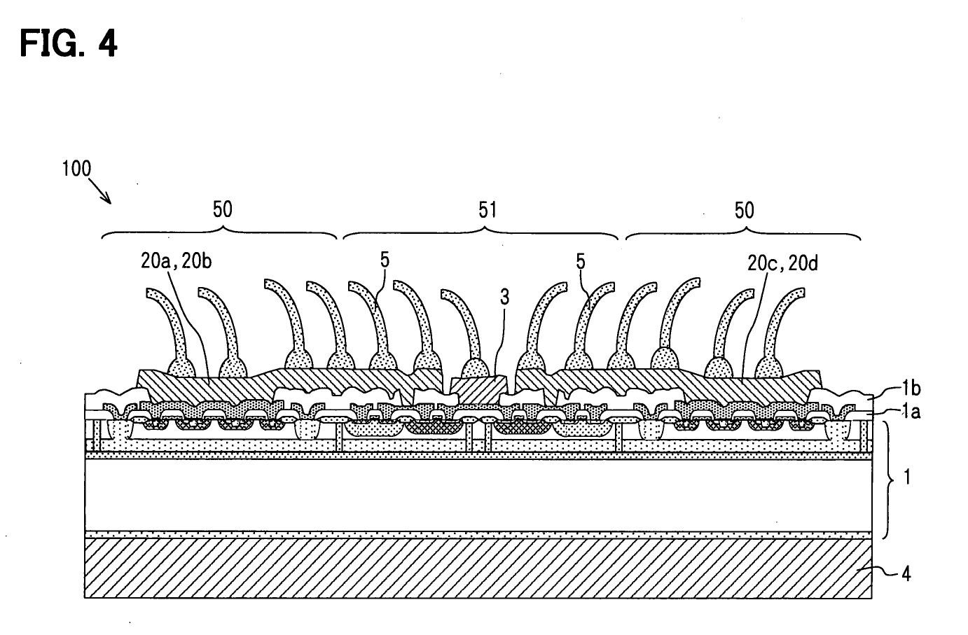

As described above, it is preferred that the number of wires for bonding to the power metal member 21a, 21b, 22a-22d becomes large. FIG. 4 shows the power IC 100 having multiple wires 5 bonding to each power metal member 20a-20d. Since the power metal member 20a-20d is disposed on the control circuit portion 51, the wire 5 is also bonded to a part of the power metal member 20a-20d disposed on the control circuit portion 51. Thus, the number of the wires 5 becomes large.

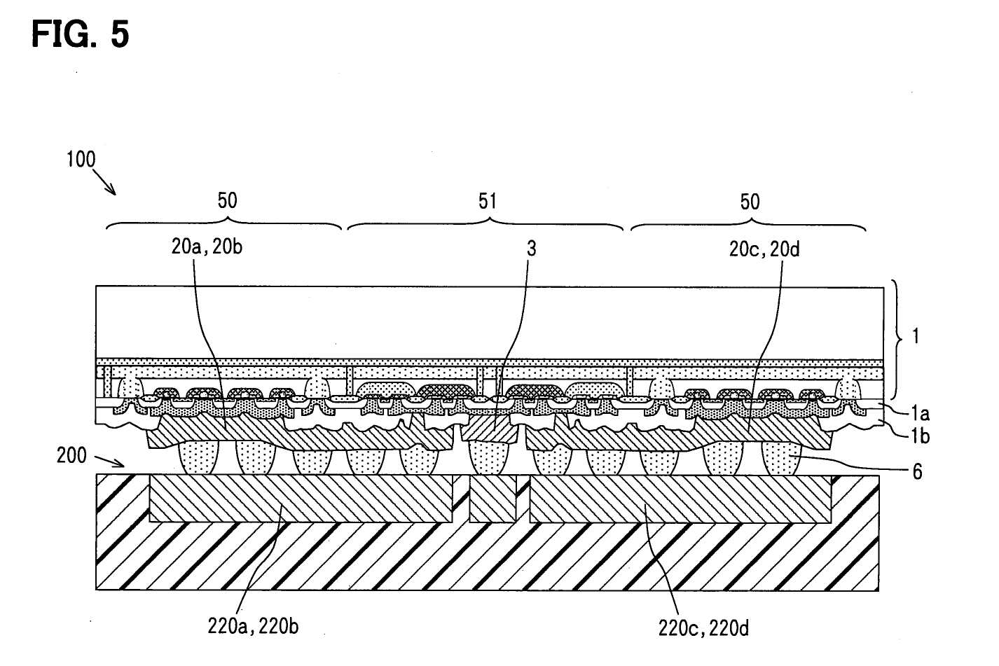

Although the wires 5 is bonded to the power metal member 20a-20d, the IC 100 may have other means for connecting to the power metal member 20a-20d. FIG. 5 shows the power IC 100 having a solder ball for connecting between the IC 100 and a printed circuit board 200. The power metal members 20a-20d are connected to wirings 220a-220d of the printed circuit board 200 through solder balls 6, respectively, so that the power IC 100 is mounted on the board 200 by a flip chip mounting method. The power metal member 20a-20d is disposed not only on the power portion 50 but also on the control circuit portion 51. Thus, the solder ball 6 is bonded to a part of the power metal member 20a-20d disposed on the control circuit portion 51.

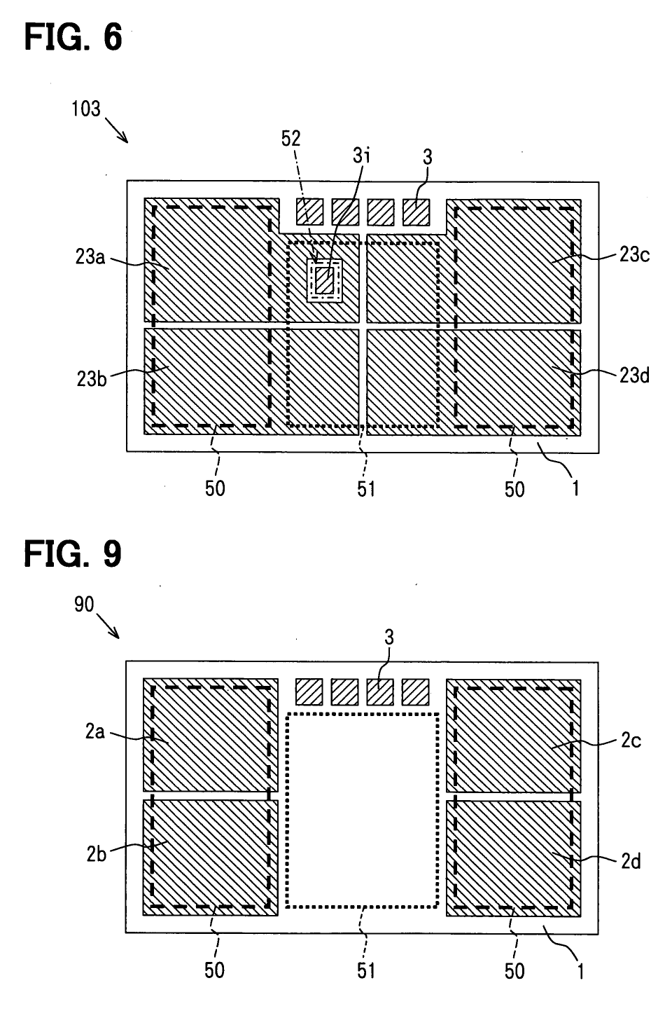

FIG. 6 shows another power IC 103. The IC 103 includes a current mirror circuit disposed in the control circuit. The characteristics of the current mirror circuit are affected by temperature gradient, so that it is required for parts in the current mirror circuit to have high uniformity of temperature. Therefore, in the power IC 103 having the current mirror circuit the power metal member 23a-23d is disposed on the control circuit portion 51 other than on the current mirror circuit, which is shown as an area surrounded with a doted-dashed line. Thus, the heat transmitting through the power metal member 23a-23d is prevented from affecting to the current mirror circuit. Alternatively, an island type metal member 3i may be disposed on the current circuit. The island type metal member 31 is not connected to the power metal member 23a-23d. The heat conductivity of the island type metal member 3i improves the heat uniformity of the current mirror circuit. Specifically, since the island type metal member 3i has small heat resistance, the temperature gradient in the current mirror circuit becomes smaller.

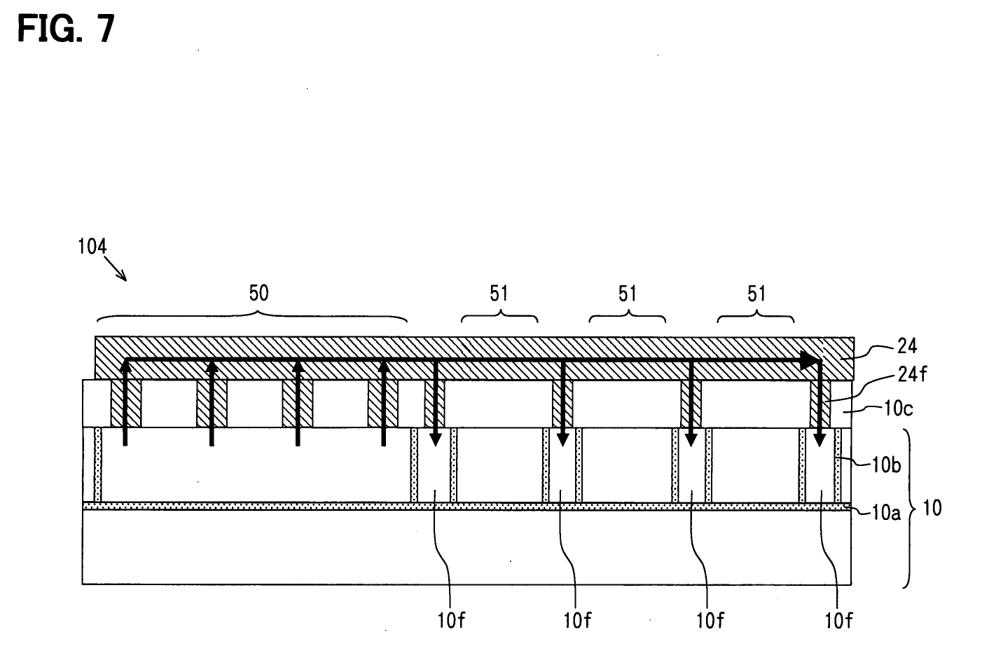

FIG. 7 shows another power IC 104 with a semiconductor substrate having SOI structure. The substrate includes a semiconductor substrate 10 and an embedded oxide film 10a. The power portion 50 is separated from the control circuit portion 51 with an insulation separation trench 10b so that the power portion 50 is electrically separated from the circuit portion 51. A field ground region 10f is formed on a periphery of the control circuit portion 51 is formed around the control circuit portion 51. The field ground region 10f is surrounded with the insulation separation trench 10b, and has no element in the region 10f.

In the IC 104 shown in FIG. 7, a power metal 24 is connected to the field ground region 10f through an embedded metal member 24f. The embedded metal member 24f is formed in an interlayer insulation film 10c, and disposed in a via hole in the interlayer insulation film 10c. Specifically, the power metal member 24 is connected to the field ground region 10f at a periphery of the control circuit portion 51. The heat shown as a heavy line in FIG. 7 is transmitted to the power metal member 24, and then, the heat is transmitted to the field ground region 10f disposed around the control circuit portion 51. Thus, the heat uniformity of the control circuit portion 51 is improved.

The above power ICs 100-104 have low on-state resistance and high heat radiation performance. Further, the temperature increase caused by the instantaneous heat generation of the power element in each IC 100-104 is limited.

Although the IC 100-104 is a power IC having the MOS transistor as a power element, the power element may be an IGBT.

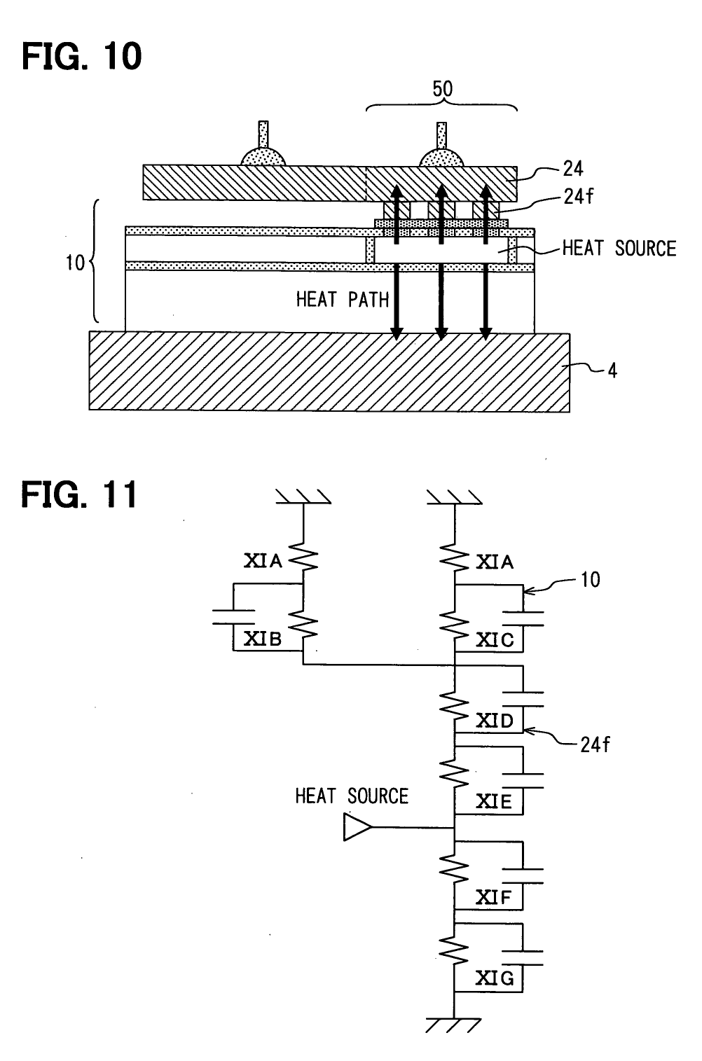

A simulation of effect of the power metal member 24 in the power IC 104 shown in FIG. 7 is performed. FIG. 10 is a simulation model of the power IC 104. The wires are boned to the power IC 104. In FIG. 10, the heat generated in the power portion 50 is transmitted on both sides of the substrate 10. Specifically, the heat is discharged from the power portion 50 through the power metal member 24 on the foreside of the substrate 10. The heat is discharged through the heat sink 4 on the backside of the substrate 10. Here, an infinite heat radiation is assumed in a simulation calculation.

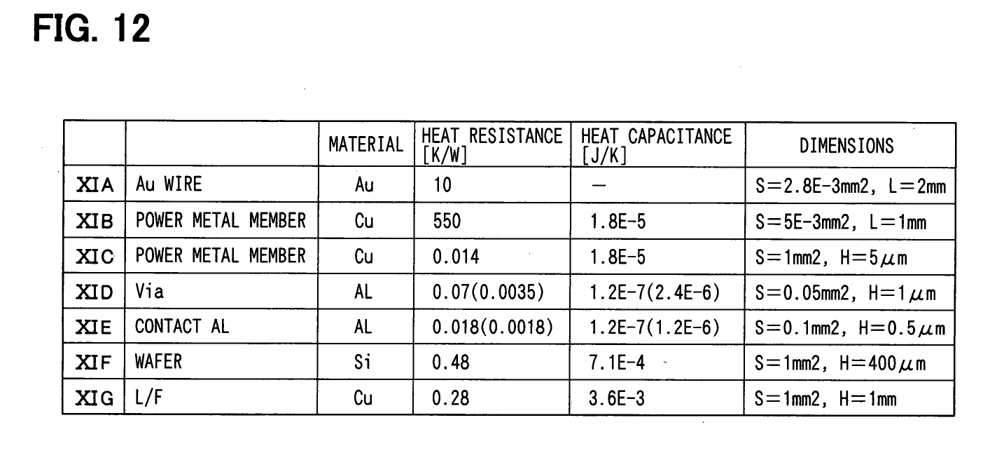

FIG. 11 is an equivalent heat circuit corresponding to the power IC shown in FIG. 10. FIG. 12 is a table showing a material, a thermal resistance, a heat capacity and dimensions of each part in the power IC 104. In FIG. 12, a bracket represents a case where a via hole disposed under the power metal member 24 expands on whole surface of the IC 104 so that the heat is transmitted through the embedded metal member 24f as a contact aluminum, which is disposed on whole surface of the substrate 10. In FIG. 11, XIA to XIG represents parts in the IC 104, which correspond to the parts in FIG. 12. In FIG. 12, S represents an area (mm²), L represents a length (mm), and H represents a height (mm) in each part XIA-XIG.

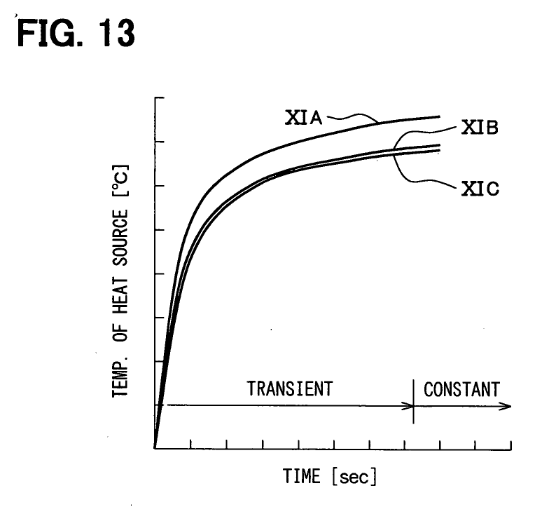

FIG. 13 shows a simulation result corresponding to the IC shown in FIGS. 10-12. In FIG. 13, XIIIA represents a case where the power IC 104 has no power metal member, XIIIB represents a case where the power IC 104 has the above construction shown in FIG. 7, and XIIIC represents a case where the power IC 104 has the embedded metal member 24f, which are disposed on whole surface of the substrate 7.

As shown in FIG. 13, when the instantaneous heat generation is occurred, firstly, a transient state of the power IC 104 starts. After a certain time passes, the power IC 104 maintains with a constant state. Regarding the instantaneous heat generation, the power IC 104 having the above described construction shown in FIG. 7 shows a reduction effect to reduce the temperature of the IC 104. This effect may depends on the layout of the power metal member 24, the dimensions of each part of the IC 104, the material of each part and the like. In this case, the reduction of the temperature of the power portion 50 is about 10%, compared with the case XIIIA having no power metal member. Specifically, the temperature of the power portion 50 in the case XIIIB after a predetermined time passes is lower than that in the case XIIIA by about 10%. In the power IC 104 shown in FIG. 7 has the embedded metal member 24f, which occupies small area of the substrate 10. The contribution of the heat resistance of the embedded metal member 24f is comparatively small, so that the heat resistance does not substantially affect the heat radiation of the power IC 104.

As described above, the power metal member 24 in the power IC 104 has sufficient heat radiation effect.

While the invention has been described with reference to preferred embodiments thereof, it is to be understood that the invention is not limited to the preferred embodiments and constructions. The invention is intended to cover various modification and equivalent arrangements. In addition, while the various combinations and configurations, which are preferred, other combinations and configurations, including more, less or only a single element, are also within the spirit and scope of the invention.

What is claimed is:

1. A semiconductor device comprising:
an element portion having a heat generation portion;
a control circuit portion having a control circuit for controlling the element portion; and
a metal member, wherein
the element portion and the control circuit portion are adjacently disposed on a surface portion of a semiconductor substrate,
the metal member as an external electrode for the element portion is disposed directly on the element portion through an interlayer insulation film, and
the metal member is also disposed directly on the control circuit portion through the interlayer insulation film.

2. The semiconductor device according to claim 1, wherein
the metal member covers almost all the element portion.

3. The semiconductor device according to claim 1, wherein
the metal member covers almost all the control circuit portion.

4. The semiconductor device according to claim 1, wherein
the element portion includes a MOS transistor, and
the metal member is an external electrode for a source or a drain of the MOS transistor.

5. The semiconductor device according to claim 1, wherein
the metal member is bonded with a plurality of wires.

6. The semiconductor device according to claim 1, wherein
the metal member is bonded to a printed circuit board through a plurality of solder balls.

7. The semiconductor device according to claim 1, wherein
the control circuit portion includes a current mirror circuit, and
the metal member is disposed on a part of the control circuit portion other than on the current mirror circuit.

8. The semiconductor device according to claim 7, further comprising:
an island type metal member disposed on the current mirror circuit, wherein
the island type metal member is not connected to the metal member.

9. The semiconductor device according to claim 1, wherein
the semiconductor substrate is a SOI substrate having an embedded oxide film,
the element portion is separated from the control circuit portion with a trench so that the element portion is electrically isolated from the control circuit portion,
the control circuit portion further includes a field ground region, in which no part is disposed,
the field ground region is surrounded with the trench, and
the metal member is connected to the field ground region at a periphery of the control circuit portion through an embedded metal member in a via hole of the interlayer insulation film.

10. The semiconductor device according to claim 1, wherein
the metal member is made of aluminum-based material or copper-based material.

11. The semiconductor device according to claim 10, wherein
the metal member is made of aluminum or copper.

12. The semiconductor device according to claim 1, further comprising:
a heat sink, wherein
the element portion and the control circuit portion are disposed on a foreside of the substrate,
the heat sink is disposed on a backside of the substrate, and
the heat sink and the metal member are capable of transmitting heat generated in the heat generation portion so that the heat is discharged.

13. The semiconductor device according to claim 12, wherein
the heat sink covers almost all the backside of the substrate, and
the metal member covers almost all the foreside of the substrate.

14. The semiconductor device according to claim 13, wherein
the heat sink and the metal member are made of material having excellent electric conductivity and thermal conductivity.
